(19) United States
(12) Patent Application Publication
(10) Pub. No.: US 2018/0338027 A1
(43) Pub. Date: Nov. 22, 2018

(54) Battery Case with Built-in Data Path

(71) Applicant: Helio Global United States LLC, Moorestown, NJ (US)

(72) Inventors: Joon Sung, Audubon, NJ (US); Ronald G. Garriques, Lake Forest, IL (US); Hans Uhlig, Novato, CA (US)

(21) Appl. No.: 15/598,013

(22) Filed: May 17, 2017

(51) Int. Cl. H04M 1/725; H01M 2/10; H01M 10/44; H04B 1/3888; H04M 1/02; H04N 7/18; H04N 5/232; H04N 5/225; H02J 7/00

(52) U.S. Cl. CPC H04M 1/72527; H01M 2/1022; H01M 10/44; H04B 1/3888; H04M 1/0202; H01M 2220/30; H04N 5/23209; H04N 5/23238; H04N 7/188; H04N 5/2257; H02J 7/0044; H04N 7/18

(57) ABSTRACT

A battery case for a mobile device, such as a mobile phone, makes a connection with the mobile device and also makes a connection with a peripherals module attached to the battery case. In one aspect, the battery case includes a built-in battery, and the battery provides power to the mobile device and/or to the peripherals module. Different power management options are available. In another aspect, the battery case includes a data path between the mobile device and the peripherals module. For example, the mobile phone may send control instructions to a camera module via the data path, and the camera module may return images via the data path. Various control and data transfer options are available.

### BACKGROUND

### 1. Field of the Invention

This disclosure relates generally to battery cases for mobile phones.

### 2. Description of Related Art

Third parties provide a large variety of after-market hardware plug-in modules to mobile devices, such as mobile phones. Typically, the mobile devices have mechanical connectors such as USB, and the hardware plug-ins connect to these mechanical connectors. However, repeated plugging and unplugging can degrade the connections over time.

Thus, there is a need for better approaches for attaching hardware plug-in modules.

### SUMMARY

The present disclosure overcomes the limitations of the prior art by providing a battery case for a mobile device, such as a mobile phone. The battery case makes a connection with the mobile device and also makes a connection with a peripherals module attached to the battery case.

In one aspect, the battery case includes a built-in battery, and the battery provides power to the mobile device and/or to the peripherals module. Different power management options are available. In another aspect, the battery case includes a data path between the mobile device and the peripherals module. For example, the mobile phone may send control instructions to a camera module via the data path, and the camera module may return images via the data path. Various control and data transfer options are available.

Other aspects include components, devices, systems, improvements, methods, processes, applications, computer readable mediums, and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the accompanying drawings, in which:

FIG. 1a is an exploded perspective view of a battery case in use.

FIG. 1b is a perspective view of a battery case in use.

FIGS. 2a-2c illustrate different connections between a battery case and a camera module.

FIGS. 3a-3b illustrate different connections between a battery case and a mobile phone.

FIGS. 4a-4b illustrate different ways to charge a battery case.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

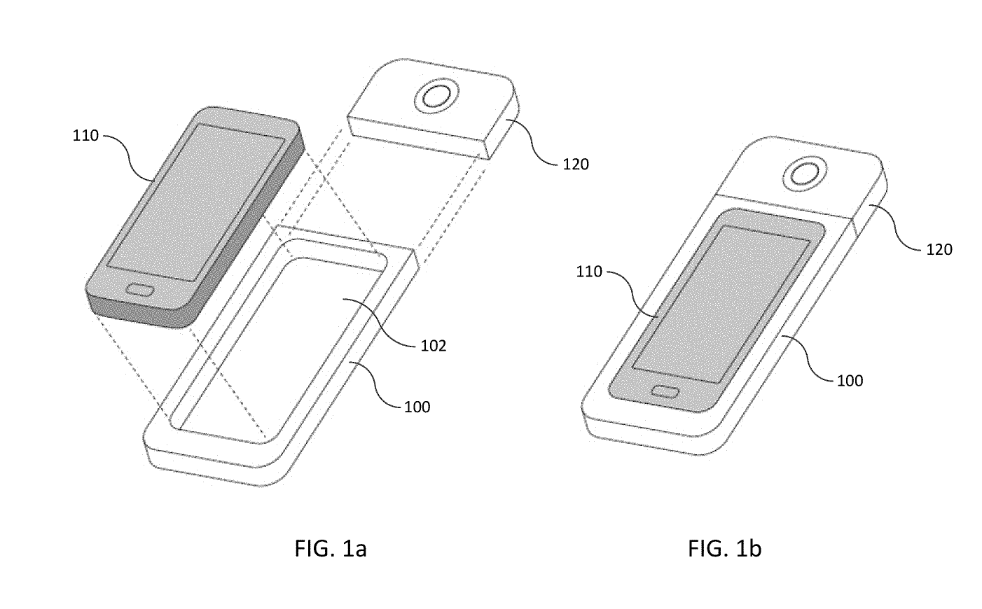

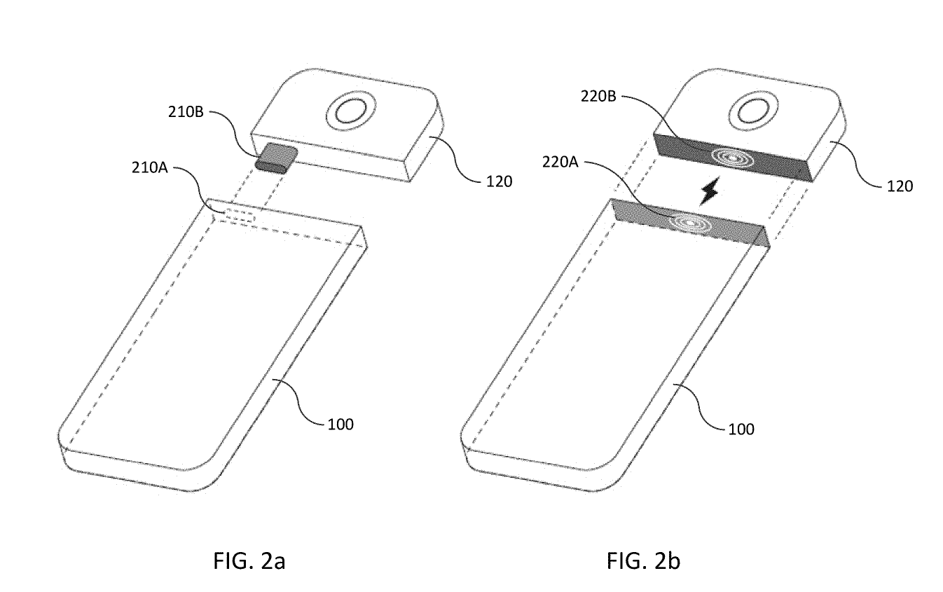

FIGS. 1a and 1b are an exploded and non-exploded perspective view of a battery case 100 in use. The battery case 100 has a cavity 102 into which a mobile device 110, such as a mobile phone, can be inserted. The battery case 100 preferably is designed to provide protection to the mobile device 110. An external peripherals module 120, such as a camera module, can also be attached and detached from the battery case 100. In this example, the peripherals module 120 is attachable to the top of the battery case 100. The battery case also includes a host port and a peripherals port (not shown in FIG. 1), which make connections to the mobile device 110 and peripherals module 120, respectively, and provide a data path between the mobile device 110 and peripherals module 120.

The battery case also has a built-in battery. In different implementations, the battery can provide power to the mobile device via the host port, to the peripherals module via the peripherals port, or to both. Alternately, the battery can provide power to the mobile device, and the mobile device powers the peripherals module.

For the remainder of this description, the mobile device is a mobile phone and the peripherals module is a 360-degree camera (camera capable of capturing a 360 degree field of view) with 4K resolution. The mobile phone sends control instructions to the camera module via the data path through the battery case, and the camera module returns image data via the data path. This is an improvement over existing 360-degree cameras because it implements a detachable 360-degree camera module with a battery case to provide more flexibility and practicability to users. Users no longer need to be frustrated about carrying a bulky 360-degree camera in addition to their smartphones. Many 360-degree cameras in the market are not palm size. Some are even bulkier by having a multi-camera setup to capture footage and requiring post-editing to stitch into 360-degree images. Some are compact size but do not offer high-quality 4K video and image resolution. The portable camera module reduces the overall size, housing a high-quality solution with 4K resolution and dual-lens for 360-degree recording in a palm size. The user can connect the camera module with the battery case by attaching it to the case as a power source to start capturing images. The user can also use the battery case as a backup battery for the phone to recharge its power and as a protector for the phone. Although much of the description uses an example of a mobile phone and a 360-degree camera, it should be understood that the battery case is not limited to these particular situations.

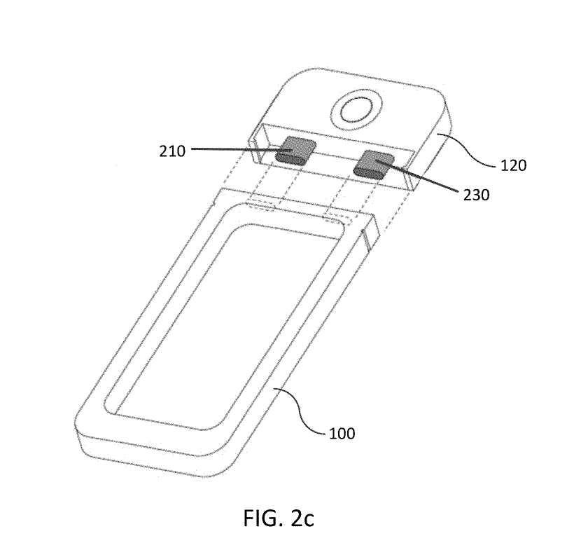

FIGS. 2a-2c illustrate different connections between a battery case and a camera module. In FIG. 2a, the connection and peripherals port uses a mechanical connector 210. The battery case 100 has a socket 210A which connect to the pins 210B of the camera. In one design, the socket 210A is a female USB connector, and the pins 210B are a male USB connector.

In FIG. 2b, the connection and peripherals port is wireless 220. The battery case 100 has a wireless power transmitter 220A and the external camera has a wireless power receiver 220B. Power is transferred from the battery case to the camera wirelessly when they are close or attached to each other.

FIG. 2c also uses a mechanical connector 210, as in FIG. 2a. However, the battery case also includes a mechanical alignment structure 230, a peg and hole in this case, to help align and fix the camera module to the battery case. In addition, the camera can have a cap shape which further improves the attachment when the connector and peg are inserted into the corresponding sockets on the battery case. Magnets could also be used.

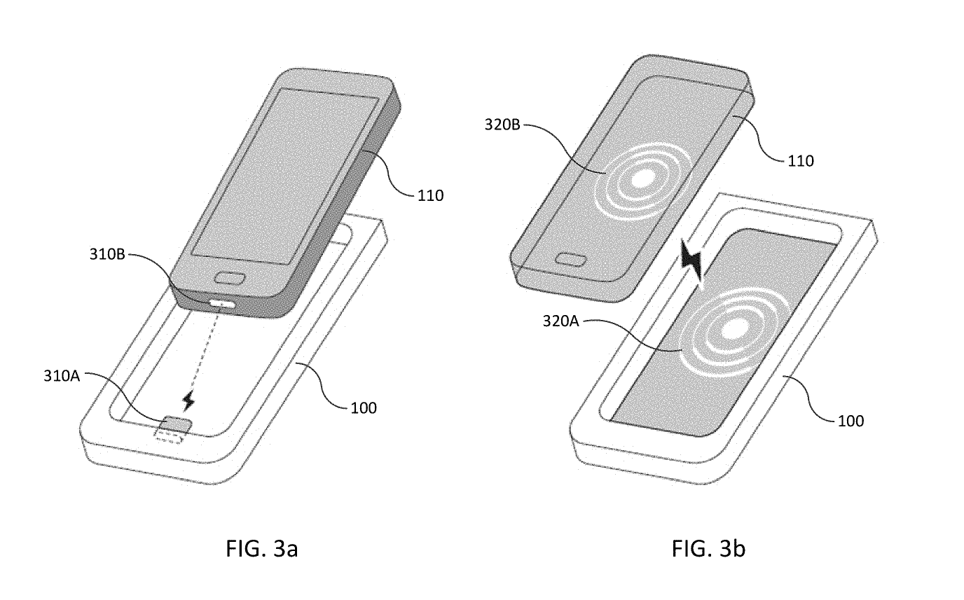

FIGS. 3a-3b illustrate different connections between a battery case and a mobile phone. In FIG. 3a, the connection and peripherals port uses a mechanical connector 310A-310B, such as a USB or Lightning connector. The mechanical connector can be the mobile device's charging socket. In FIG. 3b, the connection and peripherals port is wireless 320A-320B. For example, the mobile device may already have an integrated wireless power receiver. The battery case has a wireless power transmitter on the side facing the mobile device. When the mobile device is inserted into the battery case, power can be transferred from the battery case to the mobile device wirelessly. Mechanical connectors on the mobile device are not occupied and can be open and accessible externally for other applications.

The connections from the battery case 100 to the camera module 120 (FIG. 2) and from the battery case 100 to the mobile device 110 (FIG. 3) can be the same or different.

In cases where the battery can power both the mobile device and the camera module, there are multiple options in power management. For example, the external camera module 120 may have higher priority. When the external camera 120 is connected to the battery case 110, power is transferred only from the battery case to the camera and charging of the mobile device is disabled. Alternatively, the camera can have a switch. Power is transferred from the battery case to the camera only when the camera is turned on. In a different approach, the battery case 100 provides power to both the camera module 120 and the mobile device 110. In yet another approach, the power path (whether to camera and/or mobile device) is selected by the user, for example through a button or an app on the mobile device. In some implementations, the camera can be powered from the battery inside the mobile device.

The images taken by the camera, whether video images or still images, can also be stored in at different locations. They can be stored locally in the camera. They can be transmitted to the battery case via the peripherals port and stored in the battery case. They can be transmitted to the mobile device via the data path through the battery case and stored in the mobile device. Images can also be transferred via other data paths, for example via Wi-Fi, Bluetooth or other methods. Images can be transferred from the camera directly to the mobile device, or they can be transferred to the mobile device via the battery case.

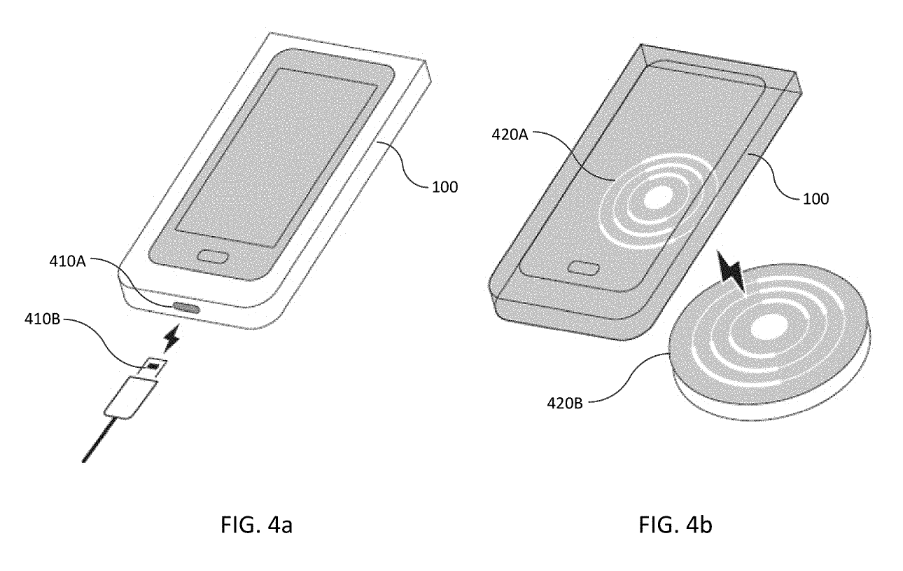

FIGS. 4a-4b illustrate different ways to charge the built-in battery in the battery case. In FIG. 4a, the battery case 100 has a charging port that is a mechanical socket 410A which can be connected to a connector 410B so that battery can be charged through a wire. In FIG. 4b, the charging port is wireless. A wireless power receiver 420A receives energy wirelessly when it is close to a compatible wireless power transmitter 420B. Note that if all connections are wireless, then the battery case can be fully sealed.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

1. A battery case for a mobile device, the battery case comprising:
a cavity configured to receive a mobile device;
a host port that makes a connection with the mobile device when the mobile device is in the cavity;
a peripherals port that makes a connection with a detachable camera module attached to the battery case;
a data path between the peripherals port and the host port, the camera module communicating with the mobile device via the data path; and
a built-in battery, the battery providing power to the camera module via the peripherals port and/or to the mobile device via the host port.

2. The battery case of claim 1 wherein the mobile device is a mobile phone.

3. The battery case of claim 2 wherein the mobile phone sends control instructions to the camera module via the data path.

4. The battery case of claim 2 wherein the camera module sends image data to the mobile phone via the data path.

5. The battery case of claim 1 wherein the detachable camera module is a 360-degree camera module.

6. The battery case of claim 5 wherein the 360-degree camera module automatically begins to capture images when attached to the battery case.

7. The battery case of claim 1 wherein the host port is a USB port.

8. The battery case of claim 1 wherein the host port is a Lightning port.

9. The battery case of claim 1 wherein the host port is a wireless port.

10. The battery case of claim 1 wherein the peripherals port is a USB port.

11. The battery case of claim 1 wherein the peripherals port is a wireless port.

12. The battery case of claim 1 wherein the host port and the peripherals port are a same type.

13. The battery case of claim 1 wherein the host port and the peripherals port are a different type.

14. The battery case of claim 1 wherein the cavity provides protection for the mobile device.

15. The battery case of claim 1 wherein the battery provides power to the mobile device via the host port.

16. The battery case of claim 1 wherein the battery provides power to the camera module via the peripherals port.

17. The battery case of claim 1 further comprising:
a mechanical alignment structure to align the camera module with the battery case.

18. The battery case of claim 1 further comprising:
one or more magnets to align the camera module with the battery case.

19. The battery case of claim 1 wherein the detachable camera module is attachable to a top of the battery case.

20. The battery case of claim 1 further comprising:
a charging port that is accessible for charging the battery while the mobile device is in the cavity.
